(19) United States
(12) Patent Application Publication
(10) Pub. No.: US 2004/0257586 A1
(43) Pub. Date: Dec. 23, 2004

(54) Common element confocal interferometer

(76) Inventor: Robert Jones, Cambridge (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/485,123

(22) PCT Filed: Jul. 25, 2002
(86) PCT No.: PCT/GB02/03454

(30) Foreign Application Priority Data
Jul. 25, 2001 (GB) 0118166.8

(51) Int. Cl. G01B 9/02

(52) U.S. Cl. 356/520

(57) ABSTRACT

The present invention concerns an interferometer in which the input light beam is incident at a non-normal angle of incidence on a pair of reflective interfaces, wherein the front surface is partially reflective and the rear interface inclined at an angle relative to the front face so that the input beam is amplitude split into two spatially offset collimated beam propagating at an angle relative to one another. Lens means are provided for focussing the beams to create a pair of focal spots in the focal plane of said lens means so that the light reflected from a measurement plane in or very near to the focal plane is re-collimated by the same lens used to focus the beams. The light then propagates back through the input beam dividing optic and recombines to cause interference.

The present invention relates to a new design of common element focussed beam interferometer for the measurement of differences in optical phase between the light passing through or reflected from two closely spaced points in space and thereby measuring the local optical phase gradient. The points are coplanar with the focal plane of a lens integral to the interferometer enabling it to be operated confocally. A system similar to this based on polarising optics has been described in an article by M. J. Downs et al, 1985, Precision Engineering, Vol 7 No. 4, pp211-215. The system described here departs from the latter in that it does not require polarising optics and also has a common element configuration that makes it intrinsically robust. It may also be linked to an external processing interferometer to enable optimal phase measurement. Linked interferometer operation requires that a light source with a coherence length less than the path differences introduced in the interferometer be used. In practice, this requires that the light source be spectrally broad-band.

In order that the present invention may be more readily understood an embodiment thereof will now be described by way of example with reference to the accompanying drawings, in which:

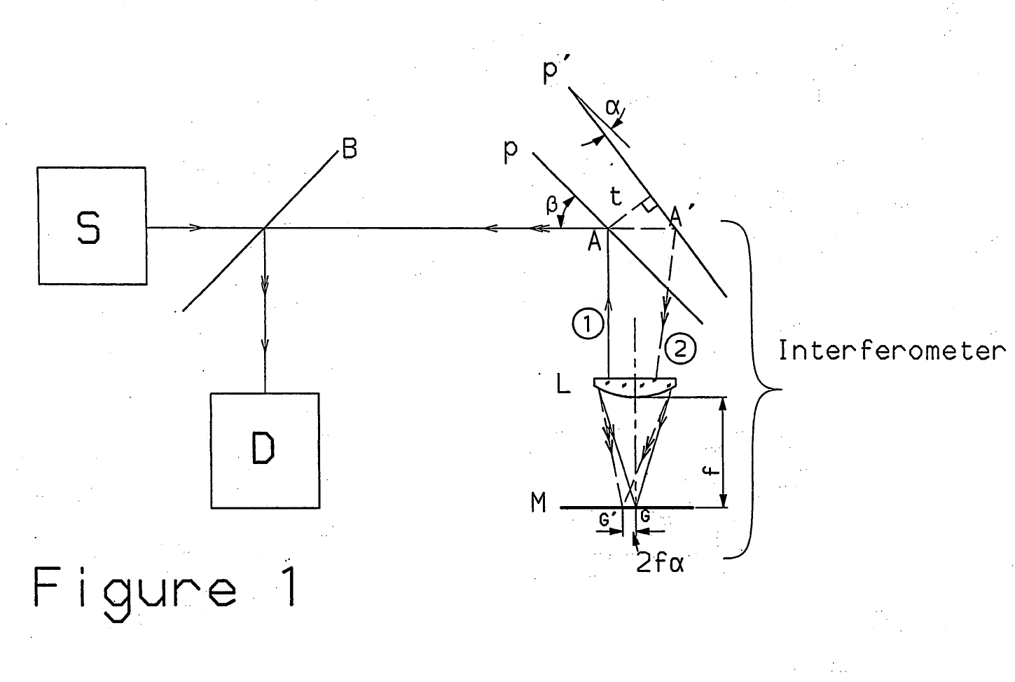

FIG. 1 is a block diagram of the general layout of system;

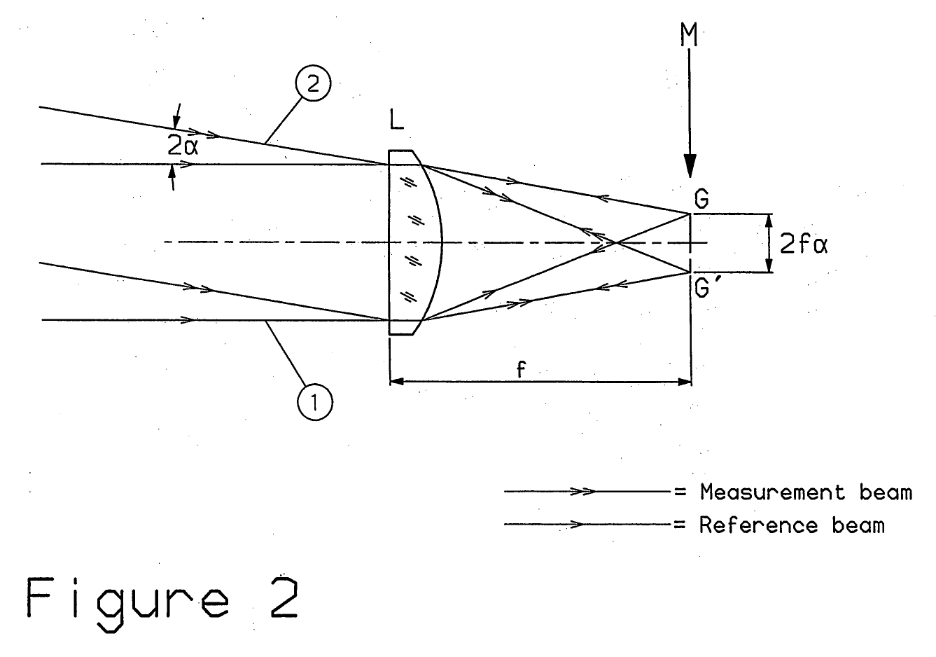

FIG. 2 shows details of the generation of a dual focal spot in focal plane of measurement M;

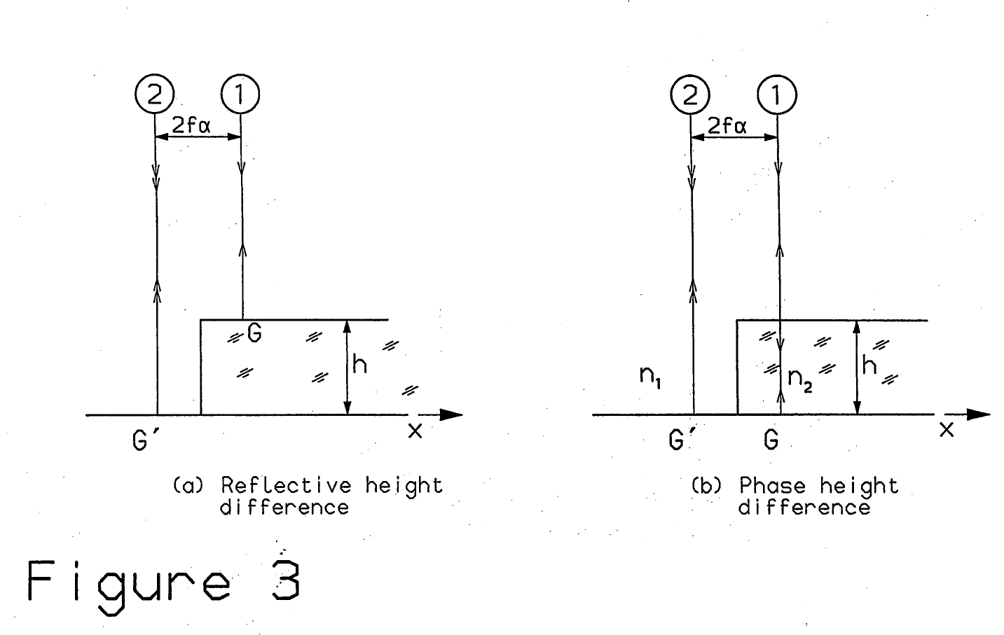

FIG. 3 shows differential phase measurement at two illumination spots;

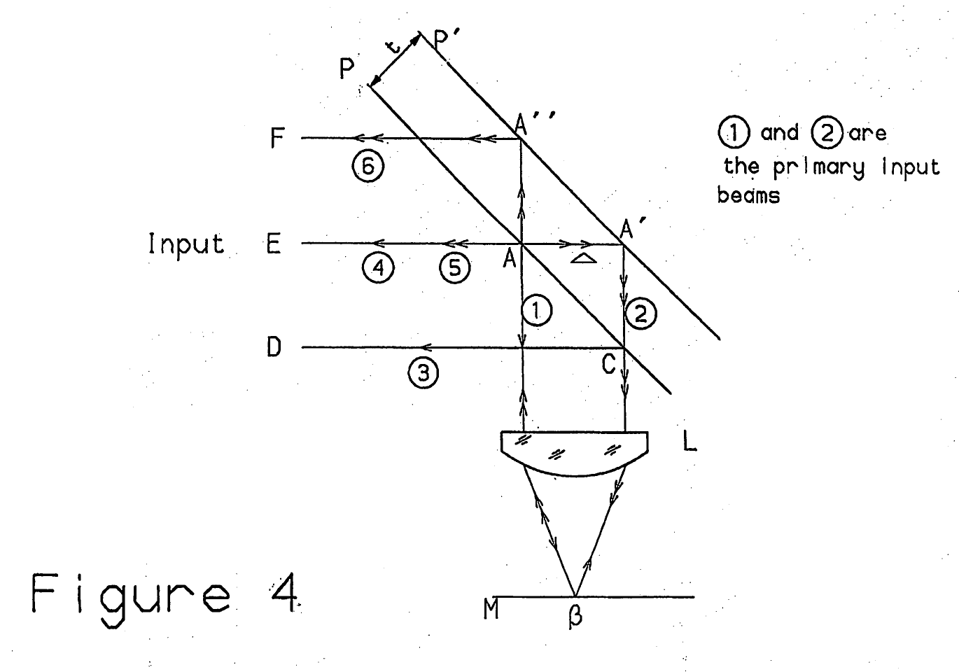

FIG. 4 shows interfering beams in confocal (retro-reflective) mode;

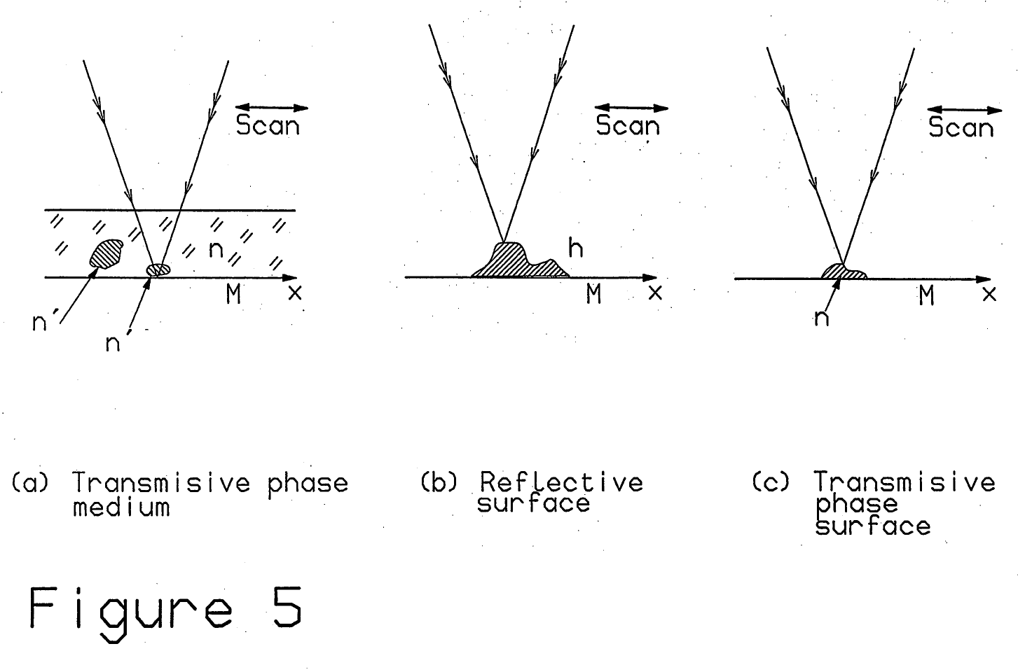

FIG. 5 shows basic modes of measurement;

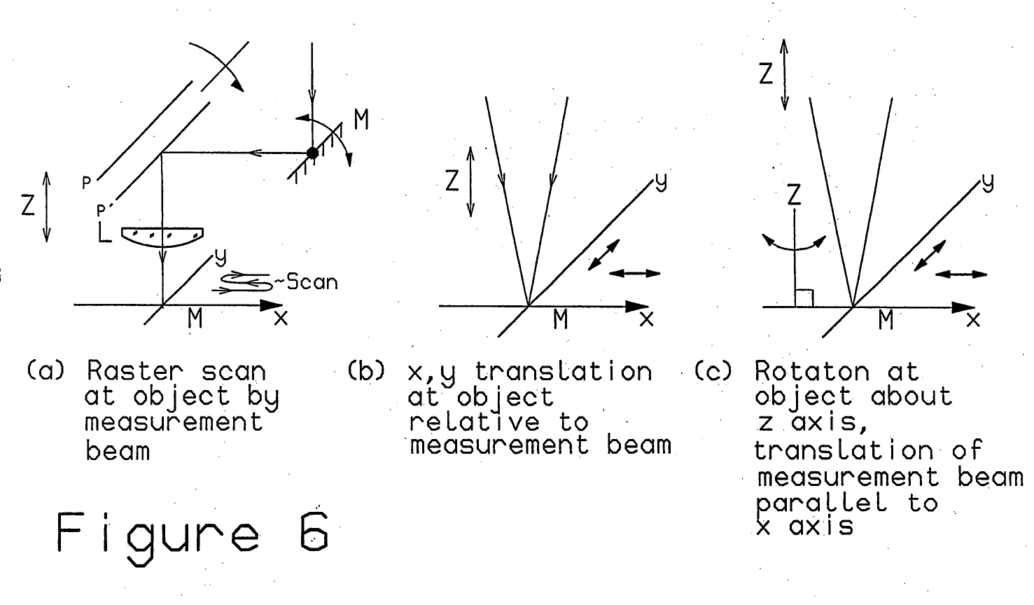

FIG. 6 shows basic modes of measurement plane scanning;

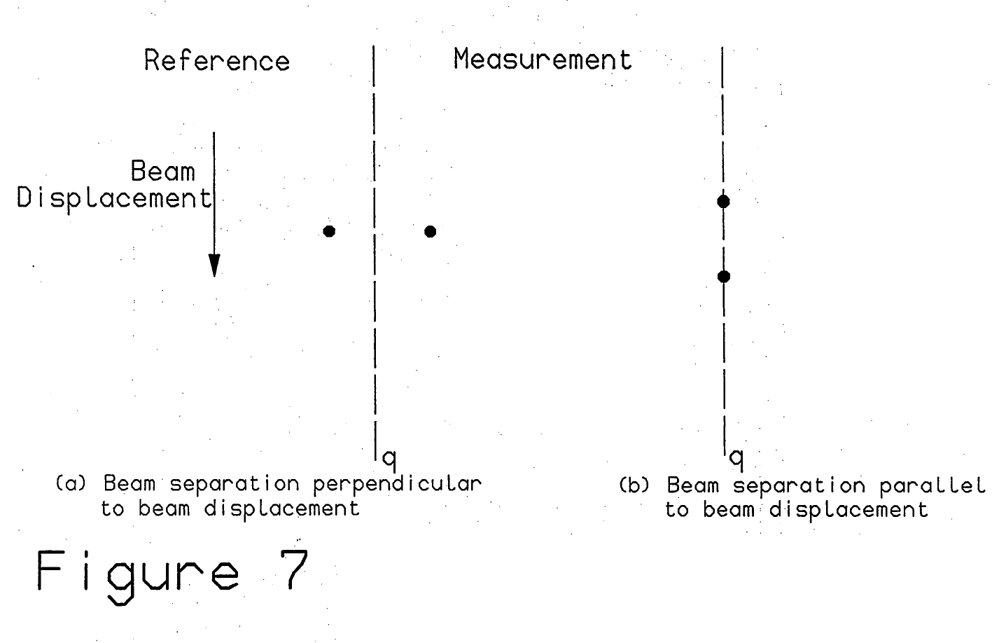

FIG. 7 illustrates the effect on measurement of the spot orientation relative to the direction of beam displacement; and

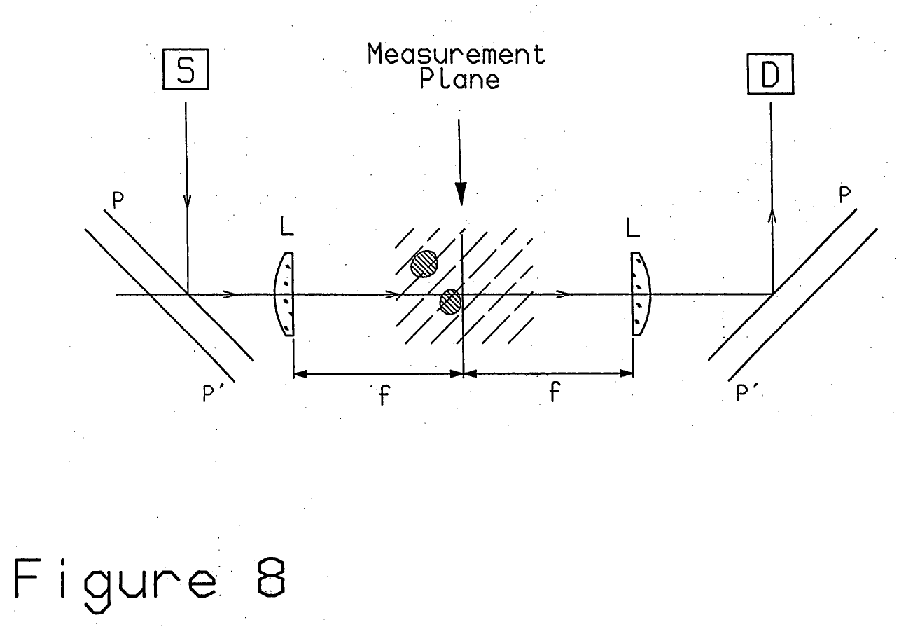

FIG. 8 shows the configuration of an interferometer for transmission measurement.

The layout of an interferometer in accordance with the present invention is shown in FIG. 1. A collimated beam of light from the source S enters the interferometer via the beam splitter B. The first component of the interferometer consists of a pair of reflective interfaces P,P¹ where P and P¹ are inclined at angle β and β+α to the incident beam. In a preferred arrangement at β is nominally 45° and in practice a is a small angle, considerably less than β. The separation of the interfaces at the point of incidence is t. The two beams reflected from the interface at P (centred at A) and the rear interface P¹ (centred at A¹) are focussed in the plane of the measurement surface M by the lens L at focal length f. The focal plane of the lens and the measurement surface are co-planar for the collimated input beam. The small angular offset α of P¹ relative to P results in two focal spots, G,G¹ with a separation 2fα being formed in the measurement surface as shown in FIG. 2. It is the interference of the light from these two spots as it is either reflected from the surface or transmitted by a phase object in close proximity to the surface, that is the basis of the interferometer. It will be recognised that the beams are effectively common path outside of a small distance either side of the focal plane. Differential changes in the interfering beam φ₁₂ are therefore due predominately to the difference in the optical path length p between points in the measurement surface separated by a distance 2fα.

This is shown diagrammatically in FIG. 3 for a reflective height difference h (FIG. 3a) and a phase height difference (n₁−n₂) h (FIG. 3b) where n₁,n₂ are the refractive indices of the adjacent transparent media.

The relative phase, φ₁₂, of the return beam is therefore

φ₁₂=2n p/λ (1)

where p=2h and 2(n₁−n₂)h for the reflective and phase height differences respectively. In the limit that fa is small we have, to a good approximation,

p=dp/dx.2fa (2)

where dp/dx is the local variation of path length p with respect to the spatial co-ordinate.

It follows from equation (1) and (2) that as the two beams are tracked across the surface in a direction parallel to their separation (i.e. the x axis), φ₁₂ is related to the local path length gradient (or phase gradient) in accordance with the equation:

dp/dx=λφ₁₂/4nfα (3)

When the object is placed in the focal plane of L it acts as a retro or cat-eye reflector. Under these conditions the interfering beams are as shown in FIG. 3 and described in Table 1.

TABLE 1
Summary of Propagation Paths and Relative
Path Lengths through Interferometer (see FIG. 4)

| | Interferometer | |
|---|---|---|
| Output Beam | Propagation Path | Path Lengths |
| 3 | A B C D | 0⁽¹⁾ |
| 4 | A B C A′ A E | 2Δ⁽²⁾ |
| 5 | A A′ C B A E | 2Δ⁽²⁾ |
| 6 | A A′ C B A A′ ′ F | 4Δ⁽¹⁾ |

⁽¹⁾Spatially off-set at interferometer output
⁽²⁾Co-axial at interferometer output

In summary there are two output beam co-axial with the input beam for which the path length difference 2Δ introduced in beam division is cancelled out on recombination and two beams 3,6 spatially offset from either side of the input beam for which the path differences is 4Δ due to the additional component 2Δ introduced on recombination (Δ is the path length of beams for a single pass between P and P¹). The additional multiple reflected beams are neglected and do not have a significant effect on the interferometer performance.

The above interfering beams may be detected at D after reflection at the beam splitter B (FIG. 1). The primary function of D is to measure the phase change φ₁₂ as defined by equations 1 to 3. A number of methods and algorithms (3), (4) may be used in combination with the specific configurations of the system discussed below.

(a) Measurement of Interference of Beams 4, 5

The interference may be detected directly at D since the beams have effectively zero relative path length. In general it will be necessary to modulate the phase of this beam in order to optimise phase measurement. For this purpose the separation of P and P¹ may be varied by known amounts by attaching either P or P¹ to a position encoded (e.g. piezoelectric) actuator.

(b) Measurement of Interference of Beams 3 and 6

If the 4Δ relative path length of these beams is made greater than the coherence length of the source they will not interfere at the primary interferometer output. (We have demonstrated experimentally that this is consistent with the use of a spectrally broad band source and PP¹ separations of order 20 to 50 micron). The beam 3 and 6 may be coupled either in free space or via an optical fibre into a second interferometer in which the path length distance. 4Δ is compensated and the interference of the beams restored. The primary advantage of this approach is that it enables to optimise phase measurement to be optimised without modulating components in the primary interferometer.

FIG. 5 illustrates the basic methods of interferometer operation.

In FIG. 5(a) a transparent phase object with elements having different refractive indices n¹,n¹¹ resides above a reflective surface placed in the measurement plane M. The interferometer will measure the refractive index gradient dn/dx in the direct vicinity of the surface, as the probe moves relative to the medium or vice-versa. The refractive index may be generated in a number of ways, for example thermally by local thermo-optic heating or by the passage of multi-phase biological fluid.

In FIG. 5(b) the interferometer measures the surface gradient of a surface irregularity. (This mode could be used for the measurement of the surface finish).

FIG. 5(c) is equivalent to FIG. 5(b) with the reflective irregularity replaced by a transmissive phase irregularity.

In all of the above, it is necessary that the focal plane beam pair move relative to the surface and in FIG. 5 different means by which this may be achieved are illustrated.

In FIG. 6(a) the element PP¹ and a second mirror M are scanned in orthogonal directions to create an x,y raster scan in the focal plane of L.

In FIG. 6(b) the object is translated in x,y relative to the fixed probe.

In FIG. 6(c) the object is rotated¹ about the Z axis and the probe translated in the x direction.

In any of the above applications the probe may be scanned in the Z axis perpendicular to M to enable the confocal sectioning of a 3D object.

The phase gradient measured will be depended upon by the orientation of the focal spots relative to the direction of translation in the measurement plane. This is illustrated in FIG. 7, where the measurement surface lies in the plane of the paper. FIG. 7a shows the beam separation perpendicular to the beam displacement. Under these conditions the output phase charge can be used to measure the relative phase of the light reflected from a reference and adjacent measurement section of the surfaces separated by the line pq, i.e. the phase gradient perpendicular to the displacement direction is measured. This may be applicable to the optical reading of data. Note also that in this arrangement the spatial resolution parallel to pq is defined by the individual spot size. In FIG. 7b the spot separation is parallel to the direction of motion and the interferometer measures the phase gradient along pq, i.e. parallel to the direction of displacement in accordance with equation (3) and the spatial reduction is defined by 2fα.

FIG. 8 shows how the interferometer may be configured for the measurement of a medium in transmission. Here the beams are recombined by a symmetrical lens and beam combining element in the transmission path.

Sensors of the above type may be configured in an array to measure multiple sites simultaneously. In such an application the outputs may be processed using a multiplexed version of the processing interferometer described in (5).

Since the sensor depth measures differential phase over a limited focal depth it is necessary to make the focal plane co-incident with the plane of measurement. For this purpose an external auto-focus sensor may be used. For this purpose a component of either of the incoherent beams 3,6 may be used in combination with known designs of optical auto-focus sensors.

1. An interferometer in which the input light beam is incident at a non-normal angle of incidence on a pair of reflective interfaces, wherein the front surface is partially reflective and the rear interface inclined at an angle relative to the front face so that the input beam is amplitude split into two spatially offset collimated beam propagating at an angle relative to one another, lens means for focussing the beams to create a pair of focal spots in the focal plane of said lens means so that the light reflected from a measurement plane in or very near to the focal plane being re-collimated by the same lens used to focus the beams and then propagate back through the input beam dividing optic and recombined to interfere with each other.

2. An interferometer in accordance with claim 1, in which the said beam dividing reflective interfaces are formed by the front and rear planar faces of a single solid optical element.

3. An interferometer in accordance with claim 1, in which the said beam dividing reflective interfaces are formed by the internal faces of a cavity formed by two planar optical flats, said flats being substantially overlapping in their planes and displaced in a direction perpendicular to their planes.

4. An interferometer in accordance with any preceding claim, in which the interfering beams correspond to the two beams that propagate co-axially after recombination at the beam division element and for which the path difference introduced by the initial beam division is compensated in the process of beam combination.

5. An interferometer in accordance with claim 1, in which the interfering means correspond to the beams that propagate along off-set parallel directions after the return pass through the beam dividing element and for which the path length difference introduced in the initial beam division is not compensated in the process of recombination.

6. An interferometer in accordance with claim 5, in which the interfering beams correspond to those for which the path length off-set introduced on beam division is nominally doubled.

7. An interferometer in accordance with claim 6, in which the path length off-set of the two beams is greater than the coherence length of the input-light source and the beams thereby made incoherent.

8. An interferometer in accordance with claim 7, in which the incoherent beams are coupled in to a second interferometer, the path length difference between the interfering paths of which is equal to the path difference between the input incoherent: beams thereby compensating for said path difference and enabling the interference of said beams to be observed on recombination at the output of the second interferometer.

9. An interferometer in accordance with claims 4 and 8, in which the relative phase of the light reflected from the two points in the focal plane measurement, surface is determined from the said interference.

10. An interferometer in accordance with claim 4, in which phase measurement is facilitated by varying the relative phase of the interfering beams by modulating the optical path length that separates the beam division elements.

11. An interferometer in accordance with claim 1, in which the separation of the focal spots is sufficient small such that to a good approximation the relative phase measured in accordance with claim 9 is proportional to the local variation of optical phase with respect to the spatial co-ordinate in the object plane, i.e. the phase gradient.

12. An interferometer in accordance with claim 11, in which the local phase gradient is generated by the passage of an optically transmitting phase object of spatially varying phase depth in the beam path above a reflective surface placed in the measurement focal plane such that the phase gradients measured corresponds to those occurring in a region of said medium in close proximity to the said reflective surface.

13. An interferometer in accordance with claim 11, in which the local phase gradient is generated by variation in the height of a reflective surface placed in the measurement focal plane.

14. An interferometer in accordance with claim 11, in which the local phase variation is generated by a transmitting phase object of varying optical depth attached to the measurement surface.

15. An interferometer in accordance with claim 1, in which an auto-focussing means is used to maintain co-incidence between the measurement plane and the focal plane of the focussing lens.

16. An interferometer in accordance with claim 15, in which either of the non-interfering beams described in claims 6 and 7 is used in an optical auto-focus sensor.

17. An interferometer in accordance with claim 1, in which the interferometer is moved relative to the plane of measurement surface or vice versa to facilitate measurement over an area of the surface.

18. An interferometer in accordance with claim 1, in which a beam scanning means is used to move the measurement beam relative to the surface.

19. An interferometer in accordance with claim 18, in which one element of said scanning system consists of the beam division element.

20. An interferometer in accordance with claim 1, in which the interferometer is moved perpendicular to the measurement surface to enable measurements to be made over the depth of an object.

21. An interferometer in accordance with claim 20, in which an auto focus means is used to identify reflective interfaces in such a medium in the plane of which measurements are subsequently made.

22. An interferometer in accordance with claim 20, in which the relative motion of the interferometer to the plane of the surface is combined with displacements perpendicular to the surface.

23. An interferometer in accordance with claim 17, in which the focal spot separation vector is perpendicular to the direction of displacement of the focal spots.

24. An interferometer in accordance with claim 17, in which the focal spot separation vector is parallel to the direction of displacement of the focal spots.

25. An interferometer in accordance with Claim 1, in which a number of said interferometers are combined to form an array to enable the simultaneous measurement of multiple sites in the surface.

26. An interferometer in accordance with claim 1, applied to the measurement of local plane gradients due to the proteins or other biological molecules and materials.

27. An interferometer in accordance with claim 1, applied to the measurement of phase gradients introduced by local heating of the medium.

28. An interferometer in accordance with claim 27, in which the local heating is generated optically.

29. An interferometer in accordance with claim 1, applied to the detection of written data bits in an optical memory.

30. A preferred implementation according to claim 29 based on the interferometer configuration described in claim 21, 22 and 23.

31. An interferometer in accordance with claim 30, as used to read out data from a multi-layer data storage media.

32. An interferometer in accordance with claim 1, in which the focal beams are incident upon a second co-axial focussing lens and recombined at a pair of interfaces identical in geometry to the initial beam dividing interfaces to thereby enable the interferometer to be operated in transmission through a medium.

33. An interferometer in accordance with claim 32, applied to the measurement of particulates transported by a medium through which the interfering beam are transmitted.

34. An interferometer in accordance with claim 26, in which the protein molecules of the biological media are contained within an electrophoresis capillary.
